(19) United States
(12) Patent Application Publication
(10) Pub. No.: US 2011/0217572 A1
(43) Pub. Date: Sep. 8, 2011

(54) DOUBLE ACTING VENTING MECHANISM FOR BATTERY CELLS

(75) Inventors: Bouziane Yebka, Apex, NC (US); Joseph A. Holung, Wake Forest, NC (US); Tin-Lup Wong, Chapel Hill, NC (US); Kenneth S. Seethaler, Wake Forest, NC (US)

(73) Assignee: Lenovo (Singapore) Pte. Ltd., Singapore (SG)

(21) Appl. No.: 12/715,949

(22) Filed: Mar. 2, 2010

(51) Int. Cl. H01M 2/12

(52) U.S. Cl. 429/56

(57) ABSTRACT

Embodiments of the invention provide battery cells having a double acting venting mechanism that provides reliable venting even in response to various undesirable events. Embodiments of the invention ensure that safe venting can take place, as necessary, even if the battery cell encounters internal and/or external pressure and/or deformation.

### BACKGROUND

The subject matter described herein generally relates to battery cells used for powering a variety of devices, such as small electronic devices, computer systems, automobiles, et cetera.

Batteries, such as rechargeable lithium-ion batteries, are used extensively in many different types of devices. For example, in electronic devices such as notebook computers, cell phones and many other portable equipment, lithium-ion batteries are primarily used because of their relatively low cost and high-energy storage capability. An increased amount of power per cell is desirable. However, it can be difficult to provide cells having more power while maintaining an acceptable safety profile for the cells.

### BRIEF SUMMARY

Embodiments of the invention provide battery cells having a double acting venting mechanism that provides reliable venting even in response to various undesirable events. Embodiments of the invention ensure that safe venting can take place, as necessary, even if the battery cell encounters internal and/or external pressure and/or deformation. Thus, battery cells equipped with venting mechanisms consistent with the embodiments of the invention have a much higher degree of safety compared with conventional battery cells.

In summary, an aspect of the invention provides a battery cell comprising: one or more terminals having one or more vents therein; a bursting disc; a current interrupt device; and a spacer; the spacer being arranged between one of said one or more terminals and the bursting disc; and the spacer being configured to ensure venting of the battery cell responsive to one or more of a disruption internal to the battery cell and a disruption external to the battery cell.

Another aspect of the invention provides an apparatus comprising: one or more battery powered elements; one or more battery packs configured to provide power to the one or more battery powered elements, the one or more battery packs comprising one or more battery cells, the one or more battery cells comprising: one or more terminals having one or more vents therein; a bursting disc; a current interrupt device; and a spacer; the spacer being arranged between one of said one or more terminals and the bursting disc; and the spacer being configured to ensure venting of the one or more battery cells responsive to one or more of a disruption internal to the one or more battery cells and a disruption external to the one or more battery cells.

A further aspect of the invention provides an apparatus comprising: one or more processors; one or more storage devices; and one or more battery packs configured to provide power to one or more of the one or more processors and the one or more storage devices, the one or more battery packs comprising one or more battery cells, the one or more battery cells comprising: one or more terminals having one or more vents therein; a bursting disc; a current interrupt device; and a spacer; the spacer being arranged between one of said one or more terminals and the bursting disc; and the spacer being configured to ensure venting of the one or more battery cells responsive to one or more of a disruption internal to the one or more battery cells and a disruption external to the one or more battery cells.

For a better understanding of the embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 (A-C) illustrates exemplary battery cell terminals in normal, current interrupt device (CID) disconnecting, and venting conditions.

FIG. 2 (A-B) illustrates a top and a side view of a clogged battery cell terminal due to internal pressure.

FIG. 3 illustrates damaged battery cell terminals due to a combination of internal and external disturbances.

FIG. 4 illustrates an exemplary venting mechanism according to an embodiment.

FIG. 5 illustrates an exemplary venting mechanism according to an embodiment.

FIG. 6 illustrates an exemplary venting mechanism according to an embodiment.

FIG. 7 illustrates an exemplary computer system.

FIG. 8 illustrates an exemplary vehicle.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the present invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the present invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments of the invention. One skilled in the relevant art will recognize, however, that aspects of the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the figures. The following description is intended only by way of example, and simply illustrates certain selected exemplary embodiments of the invention as claimed herein.

The increasing trend to package more power into a given size battery cell seems to be approaching a technology limit for some particular cell geometry, for example cylindrical cell geometry, as evidenced by an increase in safety incidents where the cell has exploded, ruptured, or vented (a forced expulsion of gases). The safety hazards from such incidents, although rare, include the potential for causing a fire and the risk of burns and other injury from projectiles and ejected cell contents. This problem has exposed some battery vendors and equipment manufacturers to unacceptable liability risks as evidenced in a number of well-publicized recalls.

The safety relief valve (vent) is one of the most important safety mechanisms on any cell. All cylindrical cells are required by law to be fitted with pressure relief devices designed to relieve excess gas pressure.

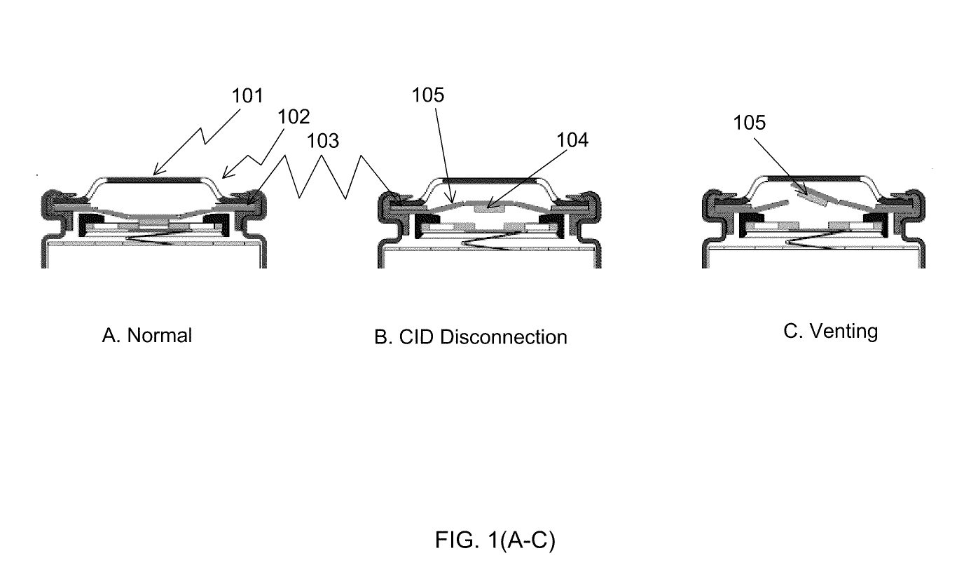

As illustrated in FIG. 1, all current production lithium-ion batteries have a venting mechanism at the top of the cell. The venting mechanism includes a terminal disc 101, a main vent 102, PTC (positive temperature coefficient) 103, current interrupt device (CID) 104, and a bursting disc/washer 105. The CID 104 is designed to disconnect electric current at a lower pressure than the bursting disk 105 itself. Should gas pressure increase to a first threshold level, the CID 104 first activates (B), and if pressure should continue to climb to a second threshold the bursting disc ruptures to release the gas (C) through the main vent.

The venting mechanism should be capable of operating at all times. Once a condition occurs that causes the pressure in a cell to increase to a dangerous level, the vent may be the only device remaining to prevent a catastrophic failure. Unfortunately, extensive heating tests show some samples still rupture (sometimes, even before thermal runaway occurs). It has been discovered that this can happen either because of internal disturbances (such as pressure build up) or external disturbances (such as physical deformation).

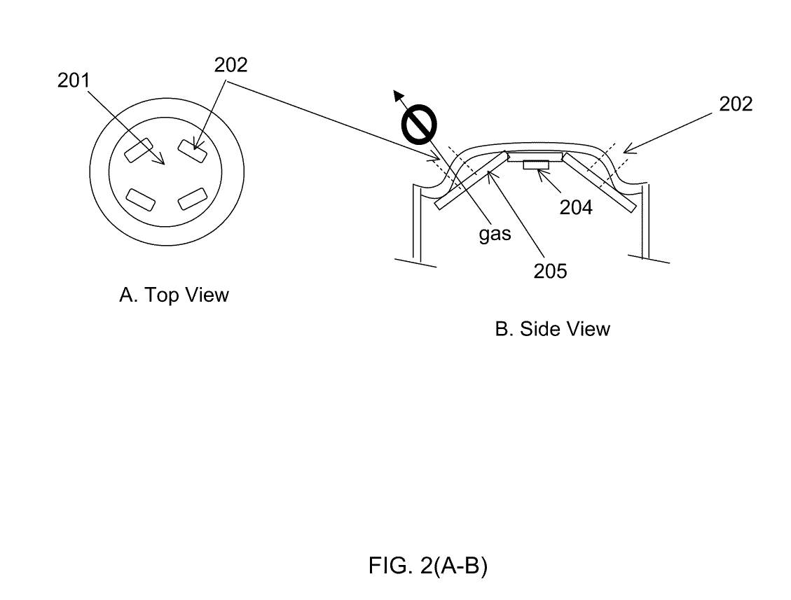

Referring to FIG. 2(A-B), investigation of some cases where the venting mechanism has failed show that the main vent 202 does not operate as expected because the bursting disc/washer 205 sometimes collapses and clogs the main venting 202 orifice on the terminal disc 201 (CID 204 is illustrated for reference). When the bursting disc/washer 205 clogs the main vent 202, the internal pressure cannot be properly vented and can lead to rupture, et cetera, of the cell.

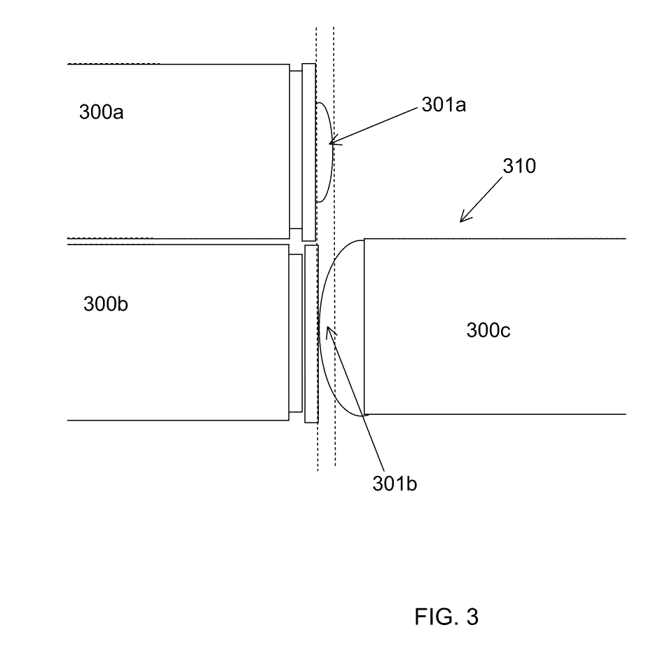

As illustrated in FIG. 3, on the other hand, visual and X-ray inspection measurements have revealed that pressure buildup inside a cell also causes significant axial expansion of the cell. As shown, in a battery pack where adjacent cells are arranged end-to-end (axial alignment) with only a small clearance between each and constrained at the ends, such expansion can result in one cell colliding and collapsing/clogging the venting mechanism of its neighbor. In FIG. 3, cell 300c has expanded 310 and impacted the end terminal of adjacent cell 300b, crushing the terminal 301b down (compare terminal 301a of cell 300a). Thus, battery cells arranged in a battery pack often propagate physical damage, as for example by expansion into an adjacent cell of the battery pack.

In view of the foregoing difficulties regarding internal and external disturbances cells may encounter, embodiments of the invention are configured to improve venting mechanisms such that the venting mechanisms are more resistant to these types of collapse/failures.

Embodiments of the invention provide venting system improvements to prevent the pressure buildup and rupture of the cell. More particularly, embodiments of the invention provide reliable double acting venting mechanisms more resistant to collapse/clogging from internal and external disturbance types, as described herein. Among other things, embodiments of the invention are configured to (1) facilitate the gas escape from the cell without clogging the vent; (2) avoid gas buildup with enough room for the venting valve to operate in a consistently smooth manner; (3) provide a mechanism that is applicable to all cell manufacturers, regardless of venting design differences; (4) essentially eliminate the potential explosion risk; and (5) provide a mechanism that can be implemented immediately and at low cost by all cell manufacturers.

Embodiments of the invention provide double acting venting mechanisms that prevent cell rupture during excessive pressure buildup. To do this, the above-outlined possibilities for clogging of the vents should be eliminated. The following embodiments illustrate several configurations for venting mechanisms that accomplish this.

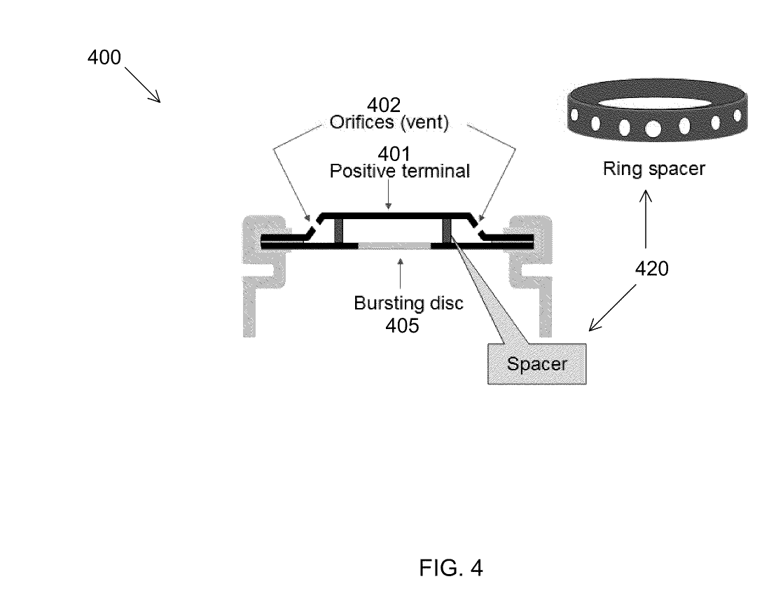

As illustrated in FIG. 4, in one embodiment, a venting mechanism 400 is provided that includes a perforated ring spacer 420. An embodiment of the invention thus provides a venting mechanism 400 including a rigid clip or spacer 420 between the bursting disc 405 and the positive terminal 401 of the cell. This maintains a fixed gap for the venting disc 405 to operate (pop up) properly. The rigidity of the disc 405 and its location provide resistance against externally and internally caused clogging.

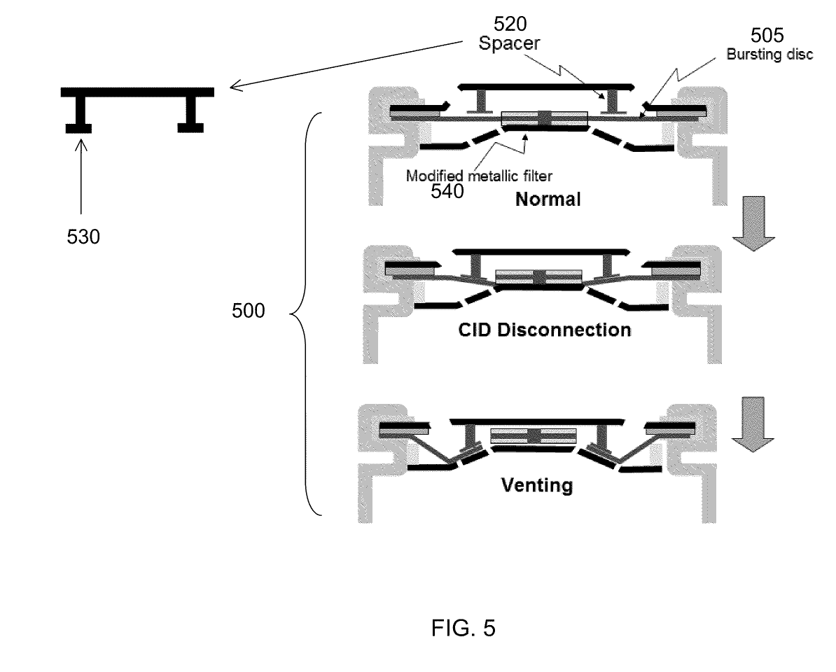

As illustrated in FIG. 5, in another embodiment, a modified spacer 520, bursting disc 505 and CID filter 540 are provided. The perforated spacer 520 has a flexible, supporting base 530 conforming with and contacting the bursting disc 505 and the bursting disc/CID filter assembly electrical contacts (505) are designed to engaged/disengage proportional to the relative axial movement between the two elements. Since behavior under both internal and external loading conditions is the same, the depictions in FIG. 5 show only one case, that is pressure from above such as derived from neighboring cell loading (external); however, this is simply done for simplicity and those having ordinary skill in the art will readily understand that the venting mechanism 500 accommodates internal pressure as well. Thus, loading from a neighboring cell causes spacer 520 to press on bursting disc 505, resulting in disengagement of the electrical contacts (contained in the middle of the bursting disc 505). A further increase in the load results in rupture of the bursting disc and venting.

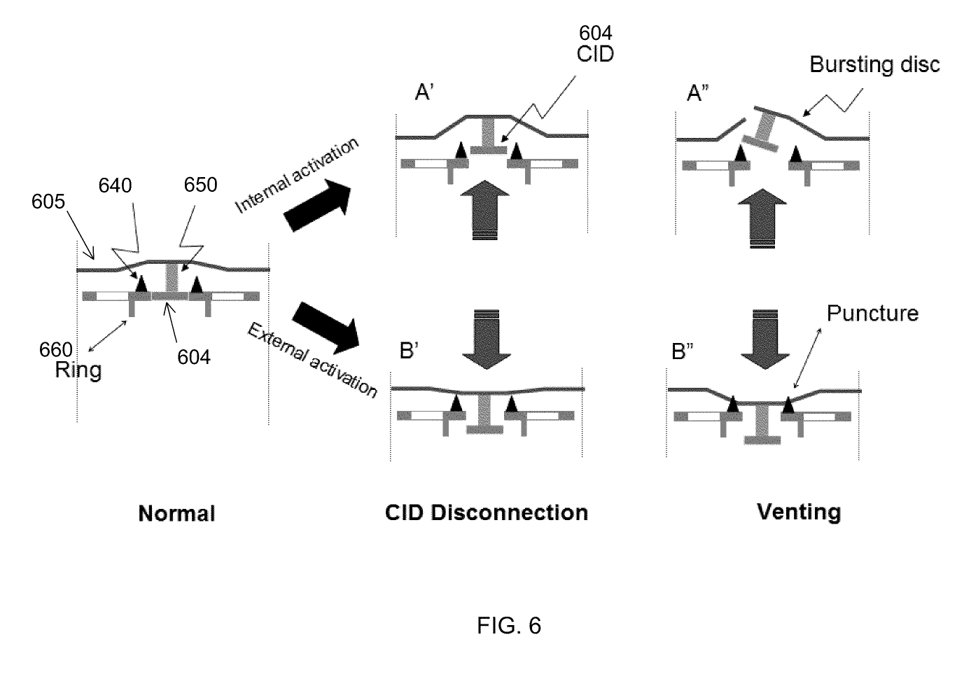

Another embodiment is illustrated in FIG. 6. As shown, a venting mechanism is provided that includes a top piercing element (for example, a ring) 640, spacer 650 and bottom ring 660. A spacer 650 is located centrally between the middle of the bursting disc 605 and the CID filter 604. A shallow but sharp-edged top piercing ring 640 with diameter larger than the bursting disc central score is centrally located between the bursting disc 605 and the CID filter 604. A lower ring 660 is centrally located between the CID filter 604 and the jelly roll assembly (not shown). Behavior under increasing internal or external pressure activates the CID 604 first, followed by venting, as depicted.

It will be understood by those having ordinary skill in the art that the embodiments of the invention can be utilized in connection with battery cells, for example arranged in a battery pack, powering any number of appropriately configured devices such as an electronic device, computer systems, electric powered automobiles (for example, a car), and the like. A non-limiting and exemplary computer system that can be powered using battery cells configured according to embodiments of the invention, for example within a battery pack, is described below.

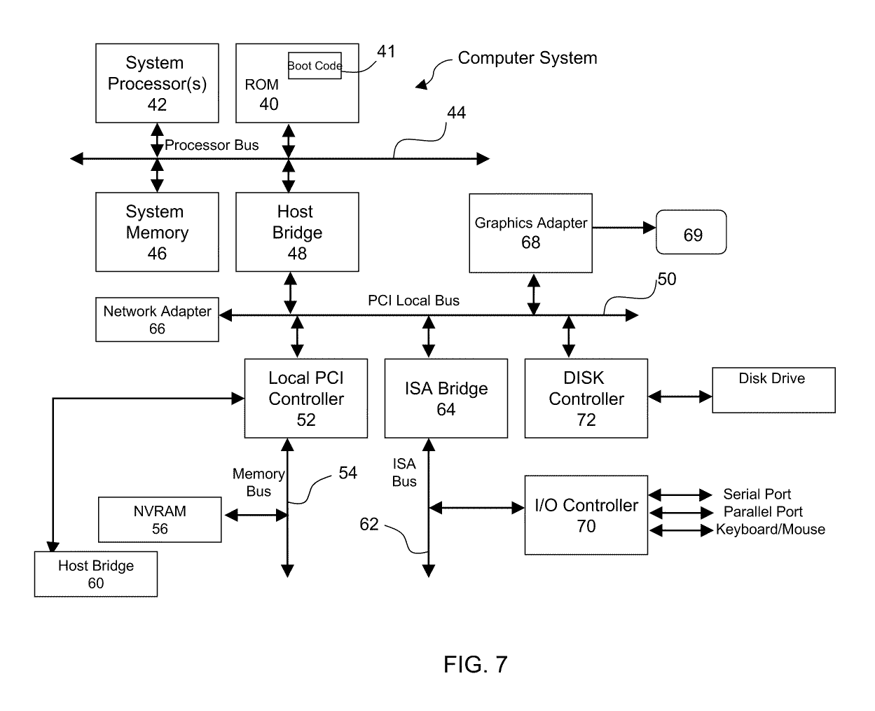

Referring now to FIG. 7, there is depicted a block diagram of an illustrative embodiment of a computer system 100. The illustrative embodiment depicted in FIG. 7 may be a notebook or laptop PC computer system, such as one of the ThinkPad® series of personal computers sold by Lenovo (US) Inc. of Morrisville, N.C. As will become apparent from the following description, however, embodiments of the invention are applicable to operation by any appropriately configured data processing system or other electronic device, including but not limited to mobile computing devices such as personal digital assistants (PDAs), smart/mobile phones, et cetera.

As shown in FIG. 7, computer system includes at least one system processor 42, which is coupled to a Read-Only Memory (ROM) 40 and a system memory 46 by a processor bus 44. System processor 42, which may comprise one of the AMD™ line of processors produced by AMD™ Corporation or a processor produced by Intel® Corporation, is a general-purpose processor that executes boot code 41 stored within ROM 40 at power-on and thereafter processes data under the control of operating system and application software stored in system memory 46. System processor 42 is coupled via processor bus 44 and host bridge 48 to Peripheral Component Interconnect (PCI) local bus 50. AMD™ is a trademark of Advanced Micro Devices, Inc. Intel® is a trademark of Intel Corporation in the U.S. and other countries.

PCI local bus 50 supports the attachment of a number of devices, including adapters and bridges. Among these devices is network adapter 66, which interfaces computer system to LAN, and graphics adapter 68, which interfaces computer system to display 69. Communication on PCI local bus 50 is governed by local PCI controller 52, which is in turn coupled to non-volatile random access memory (NVRAM) 56 via memory bus 54. Local PCI controller 52 can be coupled to additional buses and devices via a second host bridge 60.

Computer system further includes Industry Standard Architecture (ISA) bus 62, which is coupled to PCI local bus 50 by ISA bridge 64. Coupled to ISA bus 62 is an input/output (I/O) controller 70, which controls communication between computer system and attached peripheral devices such as a keyboard, mouse, etc. In addition, I/O controller 70 supports external communication by computer system 100 via serial and parallel ports. The USB Bus and USB Controller (not shown) are part of the Local PCI controller (52).

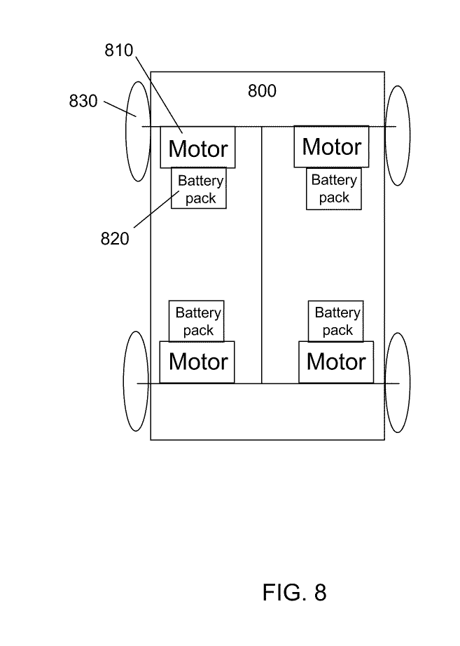

Another non-limiting example of a device that can be powered using battery cells configured according to embodiments of the invention is illustrated in FIG. 8. As illustrated, a vehicle 800, for example an automobile, can be propelled by one or more motors 810, for example positioned about a wheel 830. The one or more motors 810 can be configured to operate on battery power, as for example supplied by one or more battery packs 820. The battery packs 820 can include one or more battery cells therein.

Therefore, it should be understood and appreciated that battery cells and battery packs including battery cells, as discussed and broadly contemplated herein, can be employed in any of a very wide variety of operating environments, including computers, cell phones, other mobile devices (such as battery-operated power drills, saws, mowers and weed cutters). Thus, while FIGS. 7-8 present a computer system and a vehicle by way of possible operating environments for a battery cell having one of the various venting mechanism designs as described herein in accordance with embodiments of the invention, it of course should be understood that these are provided by way of merely illustrative and non-restrictive examples. Battery cells, as such, generally can act to power a load device or other item that is configured for being battery powered. In the case of a computer, a battery cell can serve to power various components including a main memory while in the case of an automobile a battery cell can serve to power an electric motor which propels motion in the automobile.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

In the drawings and specification there has been set forth a preferred embodiment of the invention and, although specific terms are used, the description thus given uses terminology in a generic and descriptive sense only and not for purposes of limitation.

If not otherwise stated herein, it is to be assumed that all patents, patent applications, patent publications and other publications (including web-based publications) mentioned and cited herein are hereby fully incorporated by reference herein as if set forth in their entirety.

What is claimed is:

1. A battery cell comprising:
one or more terminals having one or more vents therein;
a bursting disc;
a current interrupt device; and
a spacer;
the spacer being arranged between one of said one or more terminals and the bursting disc; and
the spacer being configured to ensure venting of the battery cell responsive to one or more of a disruption internal to the battery cell and a disruption external to the battery cell.

2. The battery cell according to claim 1, wherein the spacer further comprises a perforated spacer.

3. The battery cell according to claim 2, wherein the perforated spacer further comprises a supporting base.

4. The battery cell according to claim 1, further comprising a top piercing element disposed on said bursting disc and configured to pierce one or more of the one or more terminals.

5. The battery cell according to claim 4, further comprising a bottom spacer disposed opposite of said top piercing element relative to said bursting disc.

6. The battery cell according to claim 1, wherein said spacer comprises a ring spacer sized larger than a score of said bursting disc.

7. The battery cell according to claim 1, wherein the spacer being configured to prevent clogging of the one or more vents of the one or more terminals is configured to prevent clogging via one or more of a deformation of one of said one or more terminals in response to an external force and a deformation of one of said one or more terminals in response to an internal force.

8. The battery cell according to claim 8, wherein said external force includes a crushing force from an adjacent battery cell.

9. The battery cell according to claim 8, wherein said internal force includes a force from a buildup of gas within said battery cell.

10. An apparatus comprising:
one or more battery powered elements;
one or more battery packs configured to provide power to the one or more battery powered elements, the one or more battery packs comprising one or more battery cells, the one or more battery cells comprising:
one or more terminals having one or more vents therein;
a bursting disc;
a current interrupt device; and
a spacer;
the spacer being arranged between one of said one or more terminals and the bursting disc; and
the spacer being configured to ensure venting of the one or more battery cells responsive to one or more of a disruption internal to the one or more battery cells and a disruption external to the one or more battery cells.

11. The apparatus according to claim 10, wherein the spacer further comprises a perforated spacer.

12. The apparatus according to claim 11, wherein the perforated spacer further comprises a supporting base.

13. The apparatus according to claim 10, further comprising a top piercing element disposed on said bursting disc and configured to pierce one or more of the one or more terminals.

14. The apparatus according to claim 13, further comprising a bottom spacer disposed opposite of said top piercing element relative to said bursting disc.

15. The apparatus according to claim 10, wherein said spacer comprises a ring spacer sized larger than a score of said bursting disc.

16. The apparatus according to claim 10, wherein the spacer being configured to prevent clogging of the one or more vents of the one or more terminals is configured to prevent clogging via one or more of a deformation of one of said one or more terminals in response to an external force and a deformation of one of said one or more terminals in response to an internal force.

17. The apparatus according to claim 16, wherein said external force includes a crushing force from an adjacent battery cell.

18. The apparatus according to claim 16, wherein said internal force includes a force from a buildup of gas within said battery cell.

19. The apparatus according to claim 10, wherein the apparatus comprises one of an automobile and a computer system.

20. An apparatus comprising:
one or more processors;
one or more storage devices; and
one or more battery packs configured to provide power to one or more of the one or more processors and the one or more storage devices, the one or more battery packs comprising one or more battery cells, the one or more battery cells comprising:
one or more terminals having one or more vents therein;
a bursting disc;
a current interrupt device; and
a spacer;
the spacer being arranged between one of said one or more terminals and the bursting disc; and
the spacer being configured to ensure venting of the one or more battery cells responsive to one or more of a disruption internal to the one or more battery cells and a disruption external to the one or more battery cells.
